(19) United States
(12) Patent Application Publication
(10) Pub. No.: US 2001/0050851 A1
(43) Pub. Date: Dec. 13, 2001

(54) Modular mailbox light

(76) Inventor: Richard Warren Atkinson, Pageland, SC (US)

Correspondence Address: Richard Warren Atkinson, Route # 4, Box 54-B, Evans Mill Road, Pageland, SC, 29728, US

(21) Appl. No.: 09/875,769

(22) Filed: Jun. 6, 2001

Related U.S. Application Data
(60) Provisional application No. 60/211,146, filed on Jun. 13, 2000.

(51) Int. Cl. F21V 33/00

(52) U.S. Cl. 362/154; 362/276

(57) ABSTRACT

A self contained and compact, battery powered light emitting device for the illumination of the interior of a rural mailbox. This device is user actuated by the pressing of the unit's momentary switch. This modular device also contains a timer circuit and thus the light turns off automatically when the electronically predetermined time period is reached.

### CROSS REFERENCE TO RELATED APPLICATION

This application is entitled to the benefit of Provisional Patent Application Ser. No. 60/211,146 Filing date: Jun. 13, 2000.

### BACKGROUND

1. Background and Summary of the Invention

This invention relates primarily to curbside mailboxes and also to wherever a surface mounted and timer controlled flashlight would be of benefit.

Many of us in the United States have rural curbside mailboxes. However, for a significant number of us, it is not convenient for us to retrieve our mail in broad daylight. After all, with our busy schedules, multiple work shifts, and/or the short days of winter . . . we can't always retrieve our mail in broad daylight! Even in the early morning and late afternoon of each day (before sunrise and after sunset) we can “see outside”, but we “can not see” into the one-eyed cave that we call a mailbox!

With the above situation in mind, there is a “visible need” for light for the interior of our mailboxes. There also exists several patented methods by which to obtain this desired “lighted effect”. However, none of these patented ideas have made it in a big way into our consumer market. I believe that the reasons that they haven't are obvious. I see the other attempts a having one or more of the following negative characteristics:

1. Unsightly or clutter some, 2. Very difficult to install and thus not appealing to the consumer, 3. Very difficult to manufacture and thus “too expensive to produce”, 4. Not practical or not reliable . . . Please note that some designs allow the light to “stay on” until the batteries are “dead”, should the mailbox door be left “open” or “ajar”! In some designs, the light comes on “every time” that the door is opened . . . “day or night”! This method allows the batteries to be drained needlessly in the daytime and may leave them “discharged” for when you really need them . . . “at night”! Some mailbox light designs are made specifically for “metal” mailboxes and will not “electrically function” in non-metallic mailboxes such as those made of plastic!

In conclusion, I believe that consumers “desire” a mailbox light that is practical, easy to install, inexpensive, energy conscious, and reliable. This proposed invention, I believe, meets these demands with ease!

This invention is a modular, self contained, and battery powered device that can be easily installed in the interior of a conventional curbside mailbox. If the mailbox is made of the typical metal or plastic construction, then the invention can be easily attached to the interior of the box via a “double faced” adhesive pad. If the mailbox is made of wood or a similar material, then the invention can be attached with screws or the like. This device should be positioned horizontally against either the right or left “interior” sidewall of the box. Furthermore, the button end of the device should be positioned adjacent to the door of the mailbox. This orientation will leave the “lens end” of the device “pointing toward” the rear of the enclosure.

With this design, the light will not come on automatically. However, when the consumer desires light , then he or she will just “press and release” the conveniently located button for a blast of bright light. The consumer will not have to remember to “turn off” the unit, because it will shut itself off according to the setting of the device's timed circuit! A typical time setting for this circuit would perhaps be about 10 seconds for the mailbox application. However, an infinite choice of timed durations exists for this device. This choice, of course, will be determined by the “specific application” of this invention. Please note that this device is not limited to “mailbox applications” only!

2. Discussion of Prior Art

There have been a number of patents issued concerning the “interior lighting” of rural mailboxes. However, none of these have accomplished this feat in the simple, compact, and energy efficient way that my invention does!

For example, in U.S. Pat. No. 4,755,915, the light comes on every time that the door is opened. This discharges the battery, even in the daytime, and would “completely drain” the battery in the event that the door was left open for an extended period of time!

My invention also has a distinct advantage over U.S. Pat. No. 4,648,012. In this design, the batteries are located beneath the box and the light and switch are located on the inside of the box. My invention, as shown, is “wireless” and is much more compact and easier to install than this one!

### OBJECTS AND ADVANTAGES

Accordingly, several objects and advantages of my invention are:

1. A self-contained (modular), space saving, and low profile design that only occupies a minimal amount of space in the interior of said mailbox.

2. Invention can be “easily installed” inside an existing mailbox by using and adhesive pad.

3. No tools are necessary for installation inside an existing mailbox.

4. The invention turns on “only” when desired by the consumer and thus does not waste battery power by turning on each and every time that the door is opened.

5. The consumer does not have to “remember to turn the unit off”, as this function is accomplished by the timer circuit.

Further objects and advantages of my invention will become apparent from a consideration of the drawings and ensuing description.

### BRIEF DESCRIPTION OF THE DRAWINGS

FIG. 1 is a top side view of the housing of the light emitting device.

FIG. 2 is a left side perspective view of the housing of the light emitting device of FIG. 1.

FIG. 3 is a top side view of the circuit board of the light emitting device.

FIG. 4 is a “through the board” look at the circuit board of FIG. 3.

FIG. 5 is a schematic diagram of the electronic circuitry depicted in FIG. 3 and FIG. 4.

### DESCRIPTION OF THE PREFERRED EMBODIMENT

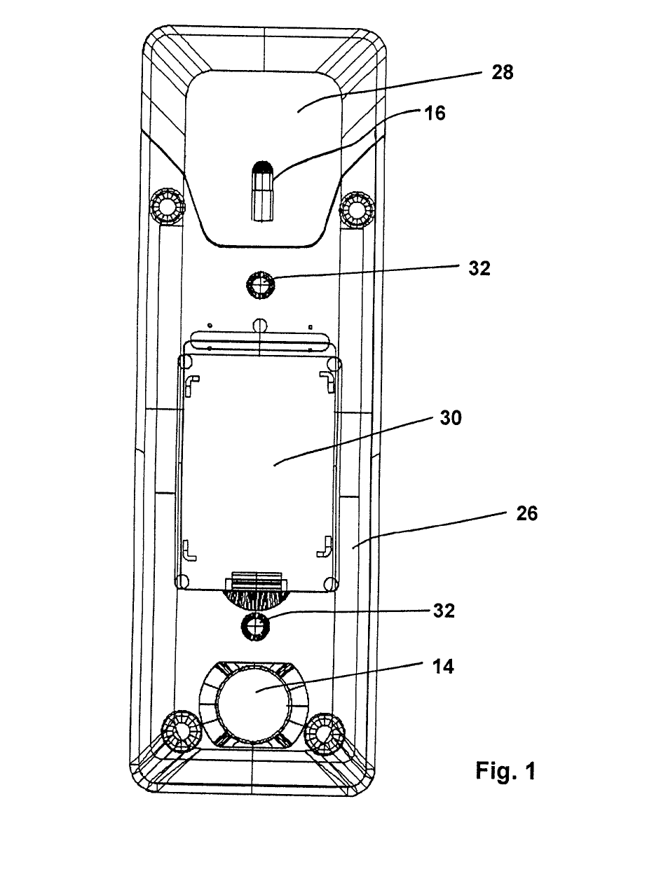

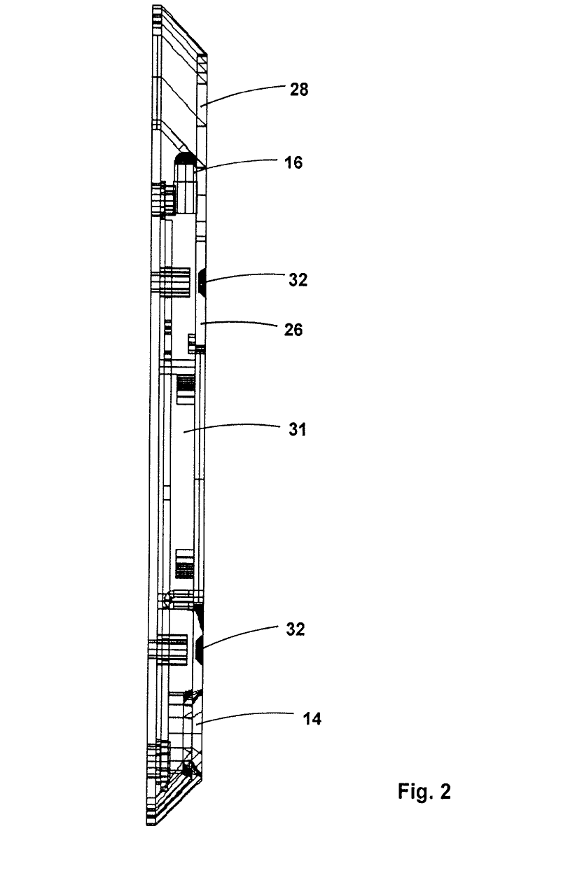

FIG. 1 and FIG. 2 are perspective views of the housing of the light emitting device. In these two drawings, housing 26 surrounds, but leaves accessible, momentary switch 14. Housing 26 is connected to battery door 30. Housing 26 is connected to lens 28 just below the location of lamp 16. Housing 26 is also comprised of two screw ports 32. One screw port 32 is located just above and the other just below battery door 30.

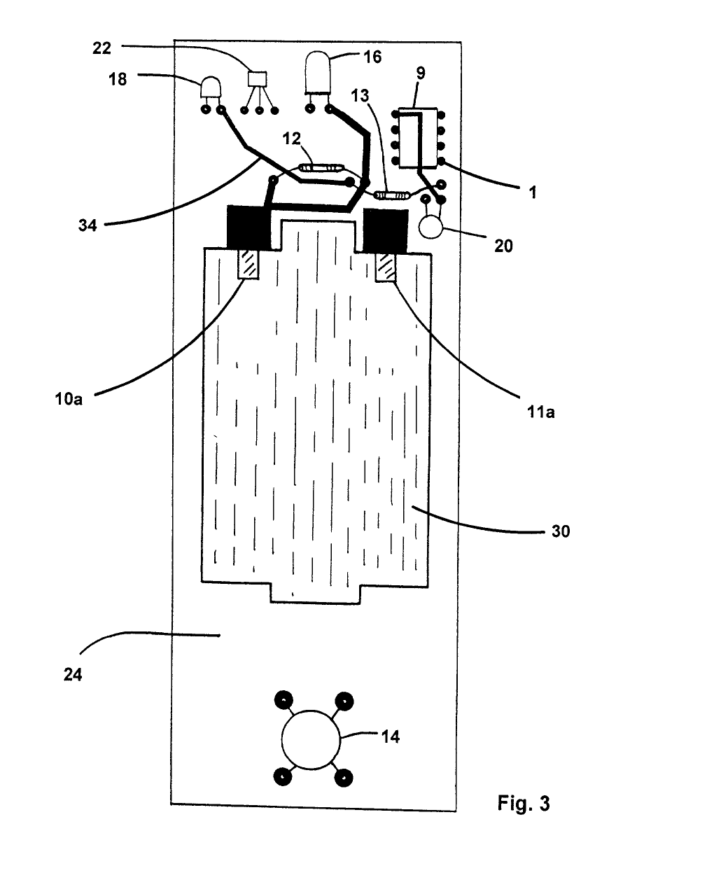

FIG. 3 is a top side perspective view of the circuit board 24 of the light emitting device. This circuit board 24 is contained within the housing 26 of FIG. 1 and FIG. 2. In FIG. 3 momentary switch 14 is connected to circuit board 24. Starting at the top left, circuit board 24 is electrically connected to capacitor 18, transistor 22, lamp 16, timer unit 9, resistor 12, resistor 13, and capacitor 20. Also connected to circuit board 24 are positive voltage terminal 10a and negative voltage terminal 11a. All said components of circuit board 24 are electrically connected by trace(s) 34.

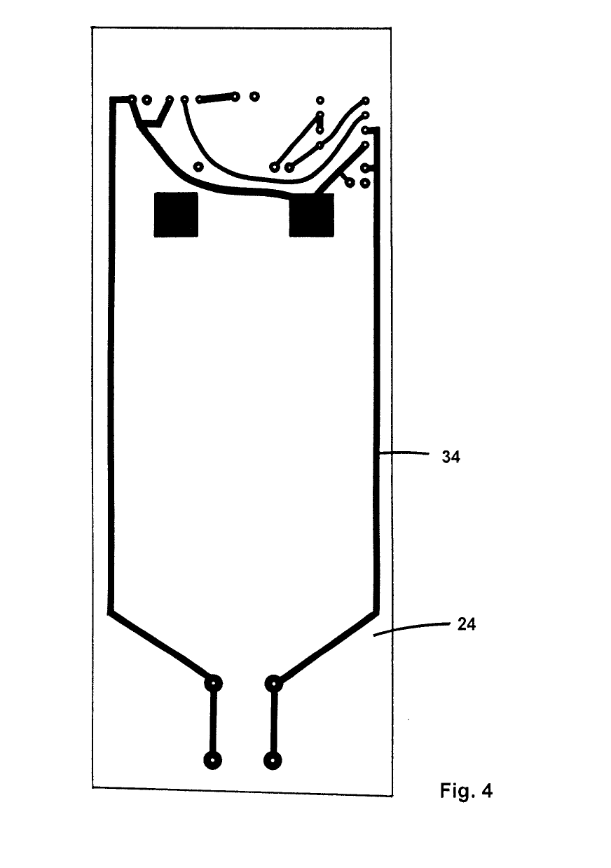

FIG. 4 is a through the board look at the circuit board 24 of FIG. 3. FIG. 4 depicts the majority of the traces 34 whereby the components of circuit board 24 in FIG. 3 are electrically connected.

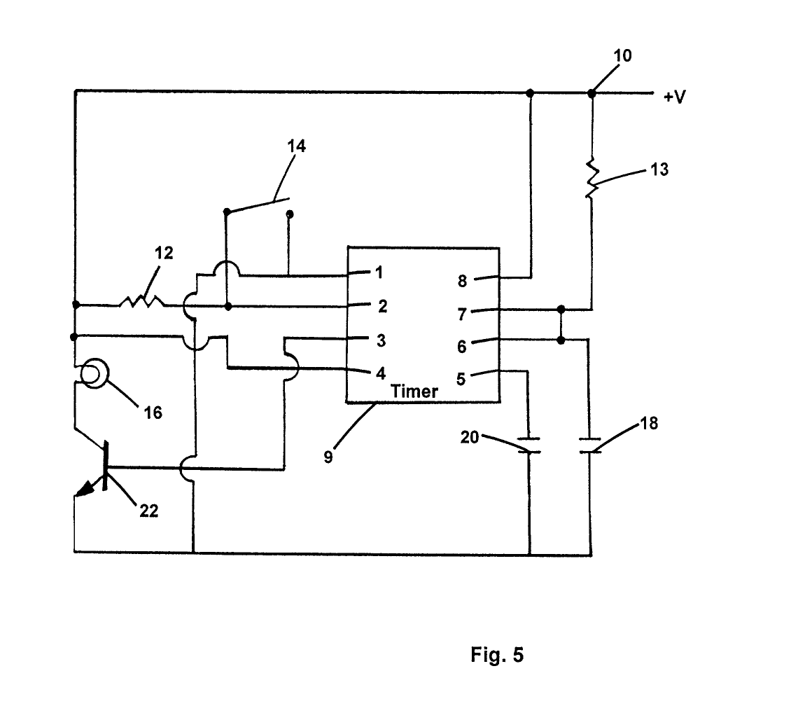

FIG. 5 is a schematic diagram of the electronic circuitry of FIG. 3 and FIG. 4. This circuitry is centered around timer 9, which has 8 terminals that are respectively numbered 1-8.

Also connected to timer 9 is positive voltage source 10, resistor 12, momentary switch 14, lamp 16, transistor 22, resistor 13, capacitor 20, and capacitor 18.

In more detail, the schematic diagram of FIG. 5 is as follows.

The positive source of voltage 10 is connected to resistor 12. The opposing side of resistor 12 is connected to momentary switch 14 and also to terminal 2 of timer 9. The positive source 10 is connected directly to lamp 16 and to terminal 8 of timer 9. The positive source 10 is connected to resistor 13. The other terminal of resistor 13 is connected to terminal 6 and terminal 7 of timer 9. Terminal 6 and terminal 7 of timer 9 are connected to the positive side of capacitor 18. The negative side of capacitor 18 is connected to ground terminal 1. Positive terminal of capacitor 20 is connected to terminal 5 of timer 9. The negative terminal of capacitor 20 is connected to terminal 1 of timer 9. Terminal 3 of timer 9 is connected to base of transistor 22. The emitter terminal of transistor 22 is connected to terminal 1 of timer 9. The collector terminal of transistor 22 is connected to one side of lamp 14.

The timer 9 is used as a time delay integrated circuit. The output of timer 9 appears on terminal 3 of said timer. The ground connection of said timer is terminal 1. Terminals 6 and 7 of timer 9 operate as the threshold and discharge inputs. Terminal 8 of said timer handles the positive source voltage. Terminal 2 of timer 9 is the trigger input.

Briefly, the circuit operates as follows. Upon momentary depression of switch 14, transistor 22 is forward bias by terminal 3 of timer 9. The emitter of transistor 22 to collector receives a negative charge to one side of lamp 16. The time duration is determined by values of resistor 13 and capacitor 18. The transistor 22 acts as a switch when a positive signal from terminal 3 of timer 9 is applied to base of transistor 22. In detail, the operation is initiated by the momentary depression of switch 14. This momentary depression sends a negative pulse to terminal 2 of timer 9. This starts the timed discharge of electrical current determined by the RC network of resistor 13 and capacitor 18. Terminal 3 output of timer 9 discharges to the base of transistor 22. Upon reception of this charge, transistor 22 starts conducting current from its emitter to its collector. As the collector is energized, it sends its charge to one terminal of lamp 16. The other terminal of lamp 16 is directly connected to positive source 10 and therefore lamp 16 is energized as soon as it receives current from the collector terminal of transistor 22.

In order to prevent “inadvertent” or false triggering of the circuit, the following have been added. One terminal of resistor 12 is connected to positive source 10. The other terminal of resistor 12 is connected to terminal 2 of timer 9. The positive terminal of capacitor 20 is connected to terminal 5 of timer 9. The negative terminal of capacitor 20 is connected to ground terminal 1 of timer 9.

The following values or designations have been found suitable for use in the circuit board 24 of FIG. 3 and FIG. 4 and seen schematically in FIG. 5. Although the following values yield about 10 seconds of bright light, they are not presented as a limitation of values for said light emitting device.

Ref.# 9/Timer Unit=low power 555 series

Ref.# 10/Positive Voltage Source=6 VDC

Ref.™ 12/Resistor=100 K ohm@¼ watt@5% tolerance

Ref.# 13/Resistor=10 MEG ohm@¼ watt@5% tolerance

Ref.# 16/Lamp=4.5 VDC@0.285 amps

Ref.# 18/Capacitor=1.0 UF@16 VDC

Ref.# 20/Capacitor=0.01 UF@50 VDC

Ref.# 22/Transistor=NPN type@2222 series

I claim:

1. In a modular, surface mounted, light emitting fixture, adapted for illuminating an adjacent area, such as the interior of a rural mailbox, said apparatus including:
a housing containing a light emitting means,
a “battery supply” within said housing,
said battery supply being electrically connected to said light emitting means,
a “press and release” activated momentary switch within said housing and electrically connected to said battery supply and to said light emitting means,
an “electronically valved” timer circuit within said housing that is electrically connected to said battery supply, to said light emitting means, and to said momentary switch.
